(19) United States
(12) Patent Application Publication
(10) Pub. No.: US 2010/0066766 A1
(43) Pub. Date: Mar. 18, 2010

(54) METHOD AND APPARATUS FOR GAMMA CORRECTION OF DISPLAY SIGNALS

(75) Inventors: Roberto Mancuso, Zurich (CH); Friedbert Riedel, Zug (CH)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/524,685

(22) PCT Filed: Jan. 28, 2008
(86) PCT No.: PCT/IB2008/050293

§ 371 Date: Jul. 27, 2009

(30) Foreign Application Priority Data
Jan. 31, 2007 (EP) 07101526.7

(51) Int. Cl. G09G 5/10; H02J 1/00

(52) U.S. Cl. 345/690; 307/38; 307/39

(57) ABSTRACT

A method and apparatus for generating gamma corrected analogue voltages uses a first ladder resistor arrangement (34) to provides a first set of analogue voltage levels. A second set of voltages (x) is selected by programming a multiplexer arrangement (36) at the output of the first ladder resistor arrangement (34). A second ladder resistor arrangement (32) is used to provide a third set of analogue voltage levels which are at intermediate voltage levels between voltage levels of the second set (x). The output (g) is the buffered voltages of the second and third sets. This arrangement enables the amount of data that needs to be programmed to be reduced to a minimum required to implement the desired differences between the gamma functions. The voltages in the second set do not need to be evenly spaced, and more variability in the shape of the gamma curve can be provided where it is needed to best reflect different characteristics of possible displays to be driven.

The present invention relates to methods and apparatus for gamma correction of display drive levels.

The most common form of pixellated colour display is currently the colour liquid crystal display (LCD). Colour LCDs typically comprise a two-dimensional array of display elements, each element including red (R), green (G) and blue (B) sub-pixels employing associated colour filters.

The display elements are driven to multiple grey levels, with the colour filters converting the grey level into a brightness for the particular colour. A digital word is used to select the desired grey level, for example a 6 bit word, and this is converted by the display driver to a voltage level for application to the display element. However, there is not a linear mapping between the digital word and the analogue voltage levels. Instead, a gamma curve provides a mapping function between the grey level code (the digital word value) and the grey level value (the analogue voltage to be applied to the display element). This function aims to map the uniform steps in the grey level code to uniform steps in perceived output brightness.

Thus, the gamma correction function of the driver IC multiplied by the gamma function of the liquid of the liquid crystal layer produces a monotonic nonlinear manipulation of the grey codes of each of the RGB pixel components, in such a way that the human eye can perceive the correct luminance of each RGB pixel.

The function depends on the characteristics of the display medium, for example the liquid crystal material, or other characteristics of the display.

The invention is described below in connection with an active matrix LCD application, but it can be easily extended to other applications that need the correction of the gamma curve, such as electroluminescent and plasma displays.

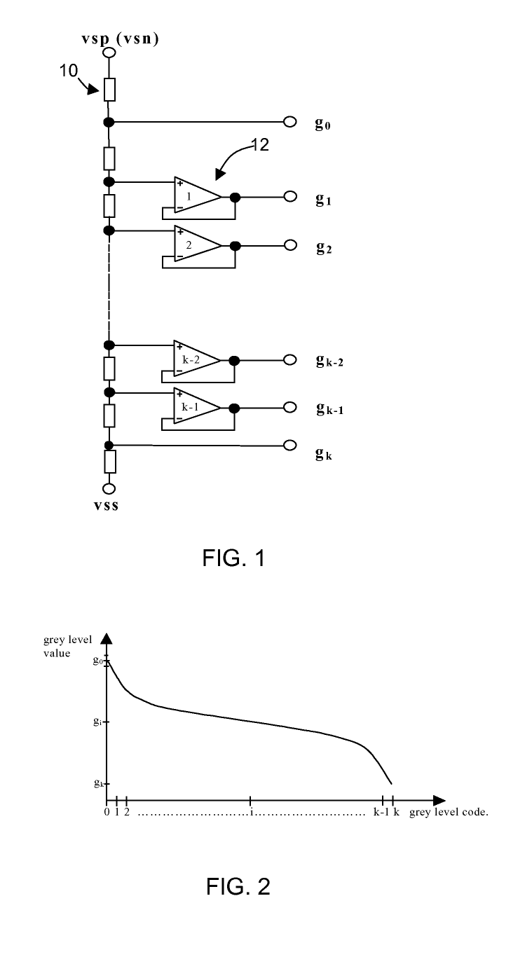

FIG. 1 shows the typical architecture for a generic static gamma correction circuit, which provides a number 0 . . . k of analogue output levels. The choice of the k points defines the static gamma correction curve.

The circuit of FIG. 1 comprise a resistor ladder 10, with each junction between resistors defining an intermediate voltage. A buffer arrangement 12 ensures minimum current is drawn by the output load (the display columns), which would otherwise distort the voltages generated.

A typical gamma correction circuit for image processing provides a nonlinear distribution of the grey levels g,. The generation of these nonlinear voltage steps is possible with using a nonlinear voltage ladder between defined voltage levels, shown as vsp or vsn (positive/negative supply voltage) and vss.

The nonlinear translation of the grey codes to the k+1 grey voltage levels as implemented by the circuit of FIG. 1 is shown in FIG. 2.

A static gamma correction circuit can correct only the gamma curve of a known liquid crystal material, but cannot correct the gamma curve of a different liquid crystal material because it has a different gamma curve. Thus, a built in IC gamma correction circuitry does not correct different gamma curves but just the one designed for.

It has been proposed to provide a programmable gamma correction voltage generator. This enables the same IC to be used for different display panel designs.

US 2005/0057482A1 discloses a programmable gamma correction voltage generator in which a resistor ladder has programmable tap points, with all tap points selected based on values for a particular gamma correction curve.

A programmable gamma correction circuit, suitable for different gamma correction curves, needs to have high accuracy of the voltage levels, to have temperature compensation and to minimize power consumption. The proposed programmable gamma correction circuits do not achieve these aims.

According to the invention, there is provided a programmable gamma correction circuit, comprising:

a first ladder resistor arrangement, which provides a first set of analogue voltage levels;

a multiplexer arrangement to which the first set of voltages is provided, and providing as output a second set of voltages, with a respective multiplexer providing each voltage of the second set, the multiplexers being programmable to enable the voltages of the second set to be selectable;

a first buffer arrangement, with each of voltage of the second set being provided to the input of a respective buffer of the first buffer arrangement;

a second ladder resistor arrangement, defined between the outputs of the buffers of the first buffer arrangement, wherein the second ladder arrangement provides a third set of analogue voltage levels which are at intermediate voltage levels between voltage levels of the second set; and

a second buffer arrangement, with each of voltage of the third set being provided to the input of a respective buffer of the second buffer arrangement.

This arrangement enables programmable levels to be chosen (to form the second voltage set) in a way which allows the selection to be independent. In particular, the voltage levels are supplied through buffers to the second resistor ladder. The second resistor ladder is then used to provide intermediate levels. In this way, the amount of data that needs to be programmed can be limited to a minimum required to implement the desired differences between the gamma functions. The voltages in the second set do not need to be evenly spaced, and more variability in the shape of the gamma curve can be provided where it is needed to best reflect different characteristics of possible displays to be driven.

Each multiplexer is preferably independently controllable, such that each voltage of the second set can be selected independently.

A temperature control unit can be provided for controlling the selection of voltages for the second set in dependence on temperature. For example, each multiplexer can receive as input a plurality of voltages from the first set, and selects one as output based on a multiplexer control signal.

Typically, the lowest and highest voltages need to be varied most between different gamma curves. In one embodiment, the voltages of the second set define a plurality of regions of output voltage, and the lowest and highest regions have intermediate voltages (of the third set) which are also programmable. This provides programmability for a number of adjacent voltage levels at the maximum and minimum ends of the voltage range.

The second ladder arrangement can have these programmable voltage selection portions associated with the lowest and highest regions, but have static voltage selection portions associated with the other regions.

The temperature compensation can be implemented by:

determining the temperature with respect to a reference temperature;

scaling a reference gamma curve according to the temperature difference; and

determining the voltages of the second set based on the scaled gamma curve.

This reduces the computation or memory required to implement temperature compensation. For the reference gamma curve, the voltages of the second set correspond to fixed static voltages of the second ladder arrangement, thereby minimizing current flow between the outputs of the buffers of the first buffer arrangement and the second ladder arrangement.

The temperature with respect to a reference temperature can be determined based on the drive voltage required for a selected output state compared to the reference drive voltage for the selected output state.

The invention also provides a display driver, comprising a gamma correction circuit of the invention for providing a set of voltages for application to the display pixels, and a voltage selection circuit for selecting one of the voltages of the set based on a pixel drive level.

The invention also provides a display device comprising a display panel; and the display driver of the invention.

The invention also provides a method of generating gamma corrected analogue voltages, comprising:

using a first ladder resistor arrangement to provides a first set of analogue voltage levels;

selecting a second set of voltages from the first set by programming a multiplexer arrangement at the output of the first ladder resistor arrangement;

buffering each voltage of the second set to a second ladder resistor arrangement and using the second ladder resistor arrangement to provide a third set of analogue voltage levels which are at intermediate voltage levels between voltage levels of the second set; and

buffering each voltage of the third set, and providing as output the buffered voltages of the second and third sets.

Embodiments of the invention will now be described, by way of example only, with reference to the following diagrams wherein:

FIG. 1 shows a known gamma correction circuit;

FIG. 2 shows the function implemented by the circuit of FIG. 1;

FIG. 3 shows schematically an example of gamma correction circuit of the invention;

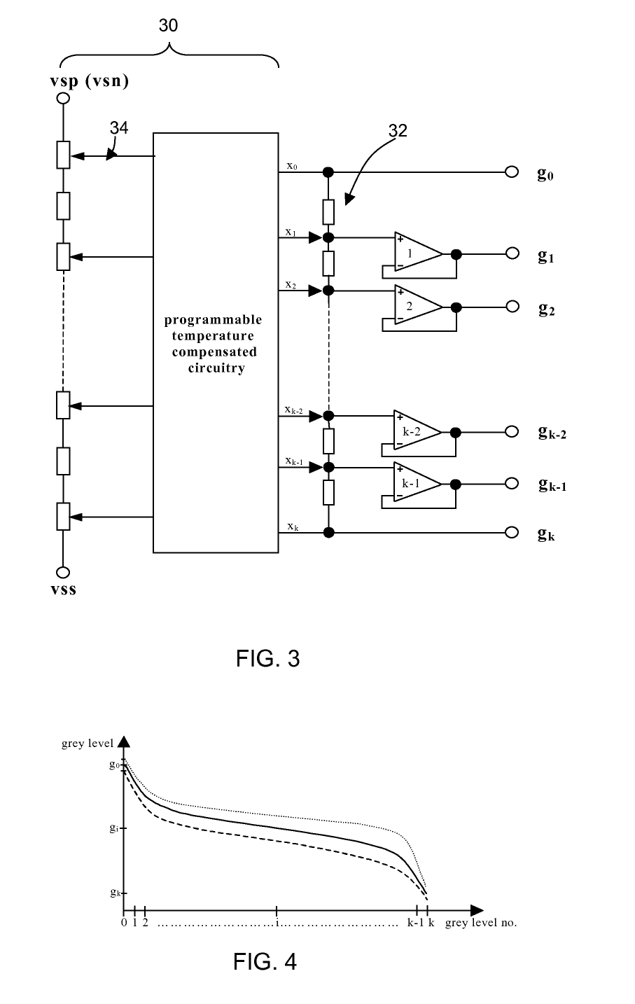

FIG. 4 shows range of functions which can be implemented by the circuit of FIG. 3;

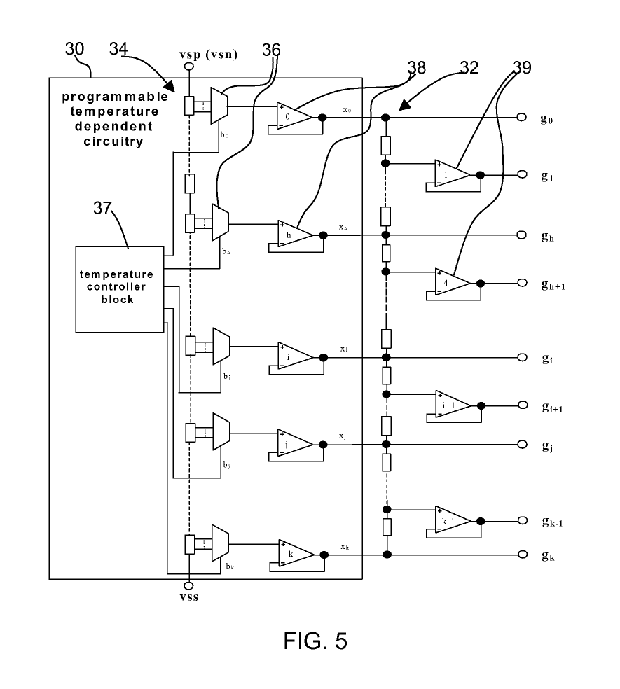

FIG. 5 shows in more detail a first implementation of the programmable part of the circuit of FIG. 3;

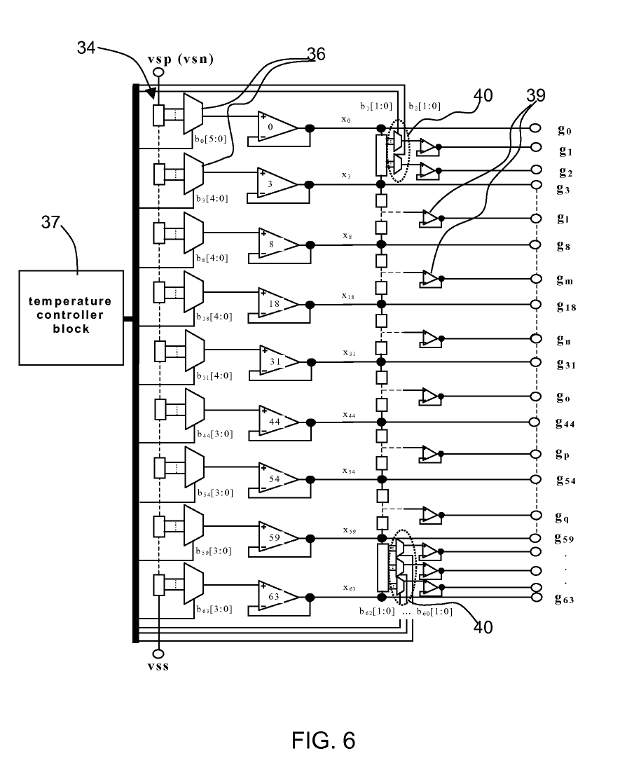

FIG. 6 shows in more detail a second implementation of the programmable part of the circuit of FIG. 3 with a change to the non-programmable part;

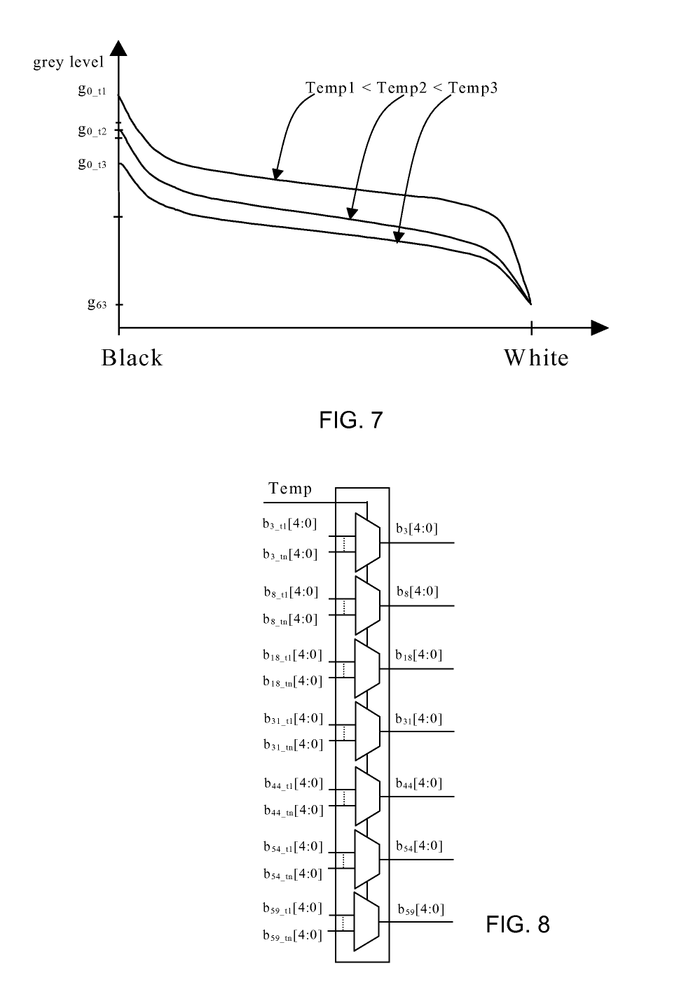

FIG. 7 shows range of functions which can be implemented by the circuit of FIG. 6;

FIG. 8 is used to explain one possible way to implement temperature compensation;

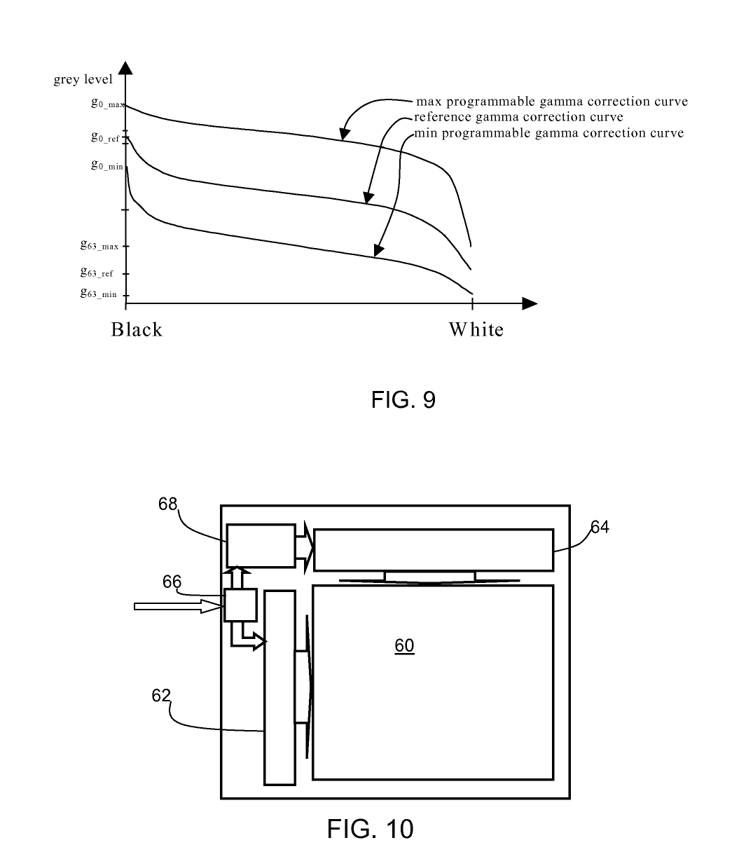

FIG. 9 is used to explain a way to implement temperature compensation according to the invention; and

FIG. 10 shows a display device of the invention.

The invention provides a programmable gamma correction circuit which uses two ladder resistor arrangements. One provides a programmable output for a subset of the voltages of the gamma function, and the other fills in the levels in the gaps. A first buffer arrangement is provided between the two ladders and a second buffer arrangement is provided at the output of the second ladder arrangement.

This arrangement enables programmable levels to be chosen in a way which allows the selection to be independent. In particular, the voltage levels are supplied through buffers to the second resistor ladder. The number of levels that can be programmed can be limited to the minimum number required to implement the desired differences between the gamma functions. The voltages in the second set do not need to be evenly spaced, and more variability in the shape of the gamma curve can be provided where it is needed to best reflect different characteristics of possible displays to be driven.

One implementation of the invention is shown in FIG. 3, in which a programmable circuit part 30 is added to a static resistor ladder circuit 32 similar to that shown in FIG. 1.

The circuit comprises two resistor ladders. One ladder 34 is used to generate grey levels and forms part of the programmable temperature compensated circuitry 30, and the other 32 generates all the other grey levels.

FIG. 4 shows the different gamma correction curves that can be programmed.

FIG. 5 shows a possible implementation of the programmable part 30 of the circuit of FIG. 3. The proposed circuitry controls the voltage level of a subset (m+1) of the k+1 levels used for the generation of the gamma correction curve.

The circuit 30 is shown to generate the levels g0, gh, gi, gk and gk.

As shown, the circuit has a resistor ladder 34 and a series of multiplexers 36. The output of each multiplexer is provided through a buffer 38 to the static resistor ladder 32.

The first resistor ladder 34 can be considered to generate a first set of levels, with a number of the levels being provided to each multiplexer 36.

Each multiplexer is supplied with a number of inputs, that may not be the same for all multiplexers. For example, a 64:1 multiplexer may be used (denoted as a multiplexer with a [5:0] select line), so that there are 64 resistor tap points, and the multiplexer enables one of these voltage taps levels to be provided as output. With similar notation, a [4:0] select line is for a 32:1 multiplexer. Thus, the multiplexers are for example 16:1, 32:1 and/or 64:1 multiplexers. The multiplexers with greater resolution will be used for the parts of the gamma curve which vary most between different displays and liquid crystal compositions.

The outputs of all multiplexers then together define a second set of voltages (the x values), and these form some of the gamma corrected output voltages. These programmable values only form a subset of the gamma corrected output values, and the other values are generated by the static resistor ladder 32.

The programmable levels are driven by the programmable circuitry and can be programmed by changing the selection inputs (bᵢ) of the multiplexers 36. The first resistor ladder 34 provides the possible inputs to the multiplexers. There are (m+1) multiplexers, one for each of the programmable levels. The programmable circuitry includes a temperature control block 37.

As (m+1) points of the gamma correction curve are programmed, the gamma correction curve will result in m segments. The second, static resistor ladder 32 is used to generate all the other levels between the (m+1) programmed levels.

All of the levels generated by the resistor ladder 32 are also buffered, as shown by buffers 39.

The intermediate levels from the second resistor ladder 32 define a third set of voltages, and together with the second set of voltages (values x) the full gamma corrected voltage sequence is generated (values g). Some of these g values have been generated by the first resistor ladder, and the others have been generated by the second resistor ladder.

FIG. 5 shows a generic circuit for the programmable circuitry. In a typical TFT application, k is 63 so that each component of the RGB code is represented by 64 grey levels (6 bits). For that case, the value of m+1 can be 9 resulting in 9 controlled points. The gamma correction curve results in m (i.e. 8) segments.

FIG. 5 schematically shows the programmable points (the second set of voltage levels x) distributed evenly amongst the output points. However, the most critical parts of the gamma correction curve are the top and the bottom parts, corresponding to the first and the eighth segment respectively. Thus, it is preferable to program all the points of these two segments as shown in FIG. 6.

In FIG. 6 the following points can be programmed by the resistor ladder 34 (in number there are m+1=9 points): g0, g3, g8, g18, g31, g44, g54, g59 and g63. Consequently the top segment is defined by the g0 and g3 levels. Similarly the bottom segment is defined by the g59 and the g63 levels.

In FIG. 6, the second ladder 32 is also provided with some programmability, but only in respect of the top and bottom segments. In particular, there is some programmability for the levels g1 and g2 and for the levels g60, g61 and g62. This programmability is again achieved using multiplexers 40.

Thus, the g1, g2, g60, g61, g62 levels can be programmed independently by means of choosing the selector inputs of the corresponding multiplexer.

FIG. 6 shows a 64:1 multiplexers for g0, 32:1 multiplexers for g3, g8, g18 and g31, and 16:1 multiplexers for g44, g54 g59 and g63.

All the levels generated from the resistor ladder 32 are again buffered.

Because the gamma curve of the liquid changes with the temperature, the programmable gamma correction curve has to be temperature compensated, meaning that the selectors of the multiplexers 36,40 have to be properly controlled by a temperature controller block 37.

In TFT applications for a normally black display, the black level, corresponding to the g0 level, is sensitive to the temperature while the white level corresponding to the g63 level, remains constant. This is shown in FIG. 7, which shows the change in gamma response of the display with temperature. For a normally white display, it is the other way around. Consequently all the grey levels have to be changed in order to keep the monotony and the shape of the gamma correction curve.

In the arrangement above, only 9 of the 64 grey levels have to be programmably controlled, so that the levels that have to be reprogrammed with temperature are only 8 (g63 is constant).

There are many ways to implement the temperature compensation of the changes of gamma curve of the liquid. The easiest way is to have a different multiplexer select value (bᵢ) for each temperature range.

Following this approach, the number of inputs will be very large. For each temperature range (t1 . . . tn), there will be a full set of bᵢ values, as shown in FIG. 8.

To avoid having too many inputs, it is preferred to have an automatic change of the b, input as function of the change of the black level g0. This enables one variable to be used to regenerate all values. Thus, an alternative approach is to change all the bᵢ values based only on the change of one of the g values with temperature, for example the g0 level for a normally black display.

In this approach, there is one gamma correction curve defined as reference, and that curve has the minimum current consumption. Based on the reference gamma correction curve defined for a specified temperature, the ratio between the g0 level and all the other programmable levels (except g63 which is constant) are well defined. The ratios are defined as “c” values:

c3=g3/g0

c8=g8/g0

c18=g18/g0

c31=g31/g0

c44=g44/g0

c54=g54/g0

c59=g59/g0

The difference of the actual g0 value and the reference one then has to be calculated:

Δg0=g0−g0_{ref}

The bᵢ values (the multiplexer control signals) are then calculated as the results of the following formulae:

b₃[4:0]=b′₃[4:0]+c3 [symbol] Δg0

b₈[4:0]=b′₈[4:0]+c8*×Δg0

b₁₈[4:0]=b′₁₈[4:0]+c18 [symbol] Δg0

b₃₁[4:0]=b′₃₁[4:0]+c31×Δg0

b₄₄[4:0]=b′₄₄[4:0]+c44×Δg0

b₅₄[4:0]=b′₅₄[4:0]+c54×Δg0

b₅₉[4:0]=b′₅₉[4:0]+c59×Δg0

The b′ values are the values for the reference gamma correction curve.

Because the results of the above formulae depends only on the reference gamma correction curve, all the possible results are predictable and can be collected in a look up table (LUT). Thus, minimal calculations have to be done. The use of a read only memory (ROM) for the LUT drastically reduces the area consumption.

A sensor is used to measure the temperature, from which the g0 value is obtained. This sensor is not a unique part of the system of invention but its information is an input to the temperature controller block.

The operation of the temperature compensation will be explained using an example.

By way of example, there may be six ranges of temperature, defined from −40 to +80 degrees Celsius. A temperature sensor indicates in which range the device is currently operating.

As preset values determined by the manufacturer, there are six different values of g0, one for each range of temperature. The manufacturer has chosen which liquid crystal composition to use, and can thus program the g0 values for each temperature range for the particular liquid crystal material. The determination of these g0 values is determined in advance and does not need to be repeated. This operation does not therefore form part of the operation of the device.

One of these possible values is a reference value g0_{ref}.

When the temperature changes, a different g0 is chosen and a different value for Δg0 will be obtained. This Δg0 value is then used as input of a look up table in combination with the reference multiplexer setting values (the b′ values).

The power consumption can be minimized by design. To achieve this, the two resistor ladders have to be designed based on the following approach:

A reference gamma correction curve has to be defined as shown in FIG. 9.

Based on the chosen reference curve, the programmable taps of the resistor ladder 32 are chosen.

When the reference gamma curve is chosen (by means of choosing the bi input values) the only two buffers that will provide current to the resistor ladder are the g0 and the g63 buffers.

All the buffers corresponding to the other programmable levels will be in the situation where their inputs (coming from the multiplexers) will correspond to their output (generated by the resistor ladder). Thus, there is no current flow between the buffer output and the resistor ladder point, and the two resistor ladders are effectively in equilibrium.

The reference gamma correction curve is then a middle curve as shown in FIG. 9.

The accuracy of the voltage levels provided by the system of the invention is made very high due to the use of the multiplexers and the buffers.

The possible error on the voltage level is only due to the offset of the buffers.

There is very high flexibility in programming different gamma correction curves.

The programmable nodes (9 in the example above) are independent from each other. For example, if the node corresponding to the voltage level g8 is changed, the other programmable nodes (g0, g3, g18, etc) will not change their voltage level. Only the intermidium levels between g3 and g8 and between g8 and g18 will change.

The power consumption can be minimized by design as discribed above. For the customer to find the appropriate gamma correction curve for the display design to be used, each voltage level can be changed independently from the others.

FIG. 10 shows a display device of the invention, comprising an array 60 of pixels, driven by a row driver 62 and a column driver 64. The input RGB input data signals are supplied to a display controller 66, and these are mapped into the required sub-pixel form by a mapping unit 68, which includes the programmable gamma correction system of the invention. The column driver 64 is used to select one of the voltages of the gamma corrected set based on the pixel drive level.

The invention can be applied to LCD displays or other display technologies, and indeed gamma correction is typically applied to many different display types to convert a digital drive signal into a linear uniform series of analogue outputs.

The arrangement above enables only the most important points in the gamma curve to be programmed, with intermediate points filled in using a static approach. This reduces the hardware and processing requirements to implement an effective gamma correction approach. For example less than half and more preferably less than one quarter of the discrete points in the gamma curve are programmable.

By selecting a reference/default gamma curve at which the ladder arrangements are balanced, the current consumption is reduced, and furthermore adjustments to the gamma curve give roughly constant current consumption.

In particular, the first resistor ladder 34 powered by vsp (or vsn) will not change its current consumption while the value of vsp (or vsn) is constant.

As explained above, during the design phase, one gamma reference is defined (for example based on some preliminary information from the manufacturer). When this gamma curve is chosen, the two resistor ladders are in equilibrium and only the g0 and g63 buffers are providing current to the second resistor ladder.

The reference gamma curve should ideally be in the middle of all possible programmable gamma curves. When a gamma curve is finally programmed by the module maker it will differ from the reference one but the distance from the reference will be kept to a minimum so that the current consumption of all the other buffers will be then minimized.

There are other image processing steps carried out before application of the drive signals to the pixels, for example sub-pixel mapping to process the image data for a particular sub-pixel layout. These additional techniques are not described above, as this invention relates specifically to gamma correction. However, the skilled person will appreciate that all other known image processing techniques can be used in conjunction with the programmable gamma correction system described above.

It should also be noted that the above-mentioned embodiments are presented purely by way of example and that numerous modifications and alterations may be realised by those skilled in the art while retaining the teachings of the invention.

1. A programmable gamma correction circuit, comprising:
a first ladder resistor arrangement, which provides a first set of analogue voltage levels;
a multiplexer arrangement to which the first set of voltages is provided, and providing as output a second set of voltages, with a respective multiplexer providing each voltage of the second set, the multiplexers being programmable to enable the voltages of the second set to be selectable;
a first buffer arrangement, with each of voltage of the second set being provided to the input of a respective buffer of the first buffer arrangement;
a second ladder resistor arrangement, defined between the outputs of the buffers of the first buffer arrangement, wherein the second ladder arrangement provides a third set of analogue voltage levels which are at intermediate voltage levels between voltage levels of the second set; and
a second buffer arrangement, with each of voltage of the third set being provided to the input of a respective buffer of the second buffer arrangement.

2. A circuit as claimed in claim 1, wherein each multiplexer is independently controllable, such that each voltage of the second set can be selected independently.

3. A circuit as claimed in claim 1, further comprising a temperature control unit, for controlling the selection of voltages for the second set in dependence on temperature.

4. A circuit as claimed in claim 1, wherein each multiplexer receives as input a plurality of voltages from the first set, and selects one as output based on a multiplexer control signal.

5. A circuit as claimed in claim 1, wherein the voltages of the second set define a plurality of regions of output voltage, and wherein the lowest and highest regions have intermediate voltages of the third set which are also programmable.

6. A circuit as claimed in claim 5, wherein the second ladder arrangement has programmable voltage selection portions associated with the lowest and highest regions, and static voltage selection portions associated with the other regions.

7. A circuit as claimed in claim 6, wherein the programmable voltage selection portions comprise multiplexers.

8. A circuit as claimed in claim 1, further comprising means for calculating the voltage on the second set based on temperature, and adapted to:
determine the temperature with respect to a reference temperature;
scale a reference gamma curve according to the temperature difference; and
determine the voltages of the second set based on the scaled gamma curve.

9. A circuit as claimed in claim 8, wherein for the reference gamma curve, the voltages of the second set correspond to fixed static voltages of the second ladder arrangement, thereby minimizing current flow between the outputs of the buffers of the first buffer arrangement and the second ladder arrangement.

10. A circuit as claimed in claim 8, wherein the temperature with respect to a reference temperature is determined based on the drive voltage required for a selected output state compared to the reference drive voltage for the selected output state.

11. A display driver, comprising:
a gamma correction circuit as claimed in claim 1 for providing a set of voltages for application to the display pixels; and
a voltage selection circuit for selecting one of the voltages of the set based on a pixel drive level.

12. A display device comprising:
a display panel; and
a display driver as claimed in claim 11.

13. A method of generating gamma corrected analogue voltages, comprising:
using a first ladder resistor arrangement to provides a first set of analogue voltage levels;
selecting a second set of voltages from the first set by programming a multiplexer arrangement at the output of the first ladder resistor arrangement;
buffering each voltage of the second set to a second ladder resistor arrangement and using the second ladder resistor arrangement to provide a third set of analogue voltage levels which are at intermediate voltage levels between voltage levels of the second set; and
buffering each voltage of the third set, and providing as output the buffered voltages of the second and third sets.

14. A method as claimed in claim 13, comprising independently controlling the multiplexers of the multiplexer arrangement such that each voltage of the second set can be selected independently.

15. A method as claimed in claim 13, further comprising controlling the selection of voltages of the second set in dependence on temperature.

16. A method as claimed in, wherein each multiplexer receives as input a plurality of voltages from first set, and selects one as output based on a multiplexer control signal.

17. A method as claimed in claim 13, wherein the voltages of the second set define a plurality of regions of output voltage, and wherein the method further comprising programming the intermediate voltages of the third set for the lowest and highest regions.

18. A method as claimed in claim 13, further comprising calculating the voltages on the second set based on temperature, by:
determining the temperature with respect to a reference temperature;
scaling a reference gamma curve according to the temperature difference; and
determining the voltages of the second set based on the scaled gamma curve.

19. A method as claimed in claim 18, wherein the temperature with respect to a reference temperature is determined based on the drive voltage required for a selected output state compared to the reference drive voltage for the selected output state.
